(19) United States
(12) Patent Application Publication
(10) Pub. No.: US 2026/0148648 A1
(43) Pub. Date: May 28, 2026

(54) AERIAL SURVEILLANCE SYSTEM AND METHOD THEREOF

(71) Applicants: HYUNDAI MOTOR COMPANY, Seoul (KR); Kia Corporation, Seoul (KR)

(72) Inventor: Jun Young LIM, Hwaseong-si (KR)

(21) Appl. No.: 19/175,433

(22) Filed: Apr. 10, 2025

(30) Foreign Application Priority Data
Nov. 27, 2024 (KR) 10-2024-0172701

(51) Int. Cl. G08G 5/80; G06V 10/80; G08G 5/265; G08G 5/72

(52) U.S. Cl. CPC G08G 5/80; G06V 10/80; G08G 5/265; G08G 5/727

(57) ABSTRACT

An aerial surveillance system includes a plurality of sensors and a radar system configured to detect a moving object around a take-off and landing site, and a server that communicates with the plurality of sensors and the radar system and includes a processor, a memory, and a network interface. The processor generates first detection data of the detected moving object based on pieces of data received from the plurality of sensors, determines whether the detected moving object is a low-altitude moving object based on the first detection data, generates second detection data of the moving object based on data received from the radar system, and generates and transmits fusion detection data of the moving object to one or more external systems based on the first detection data, the second detection data, and a determination whether the moving object is the low-altitude moving object.

### CROSS-REFERENCE TO RELATED APPLICATION

This application claims the benefit of priority to Korean Patent Application No. 10-2024-0172701, filed in the Korean Intellectual Property Office, on Nov. 27, 2024, the entire contents of which are incorporated herein by reference.

### TECHNICAL FIELD

The present disclosure relates to a sensor fusion-based low-altitude aerial surveillance system and a method thereof, and more particularly, relates to technologies for fusing pieces of data of a plurality of sensor modules and a radar system arranged around a take-off and landing site and accurately identifying and tracking a low-altitude moving object to provide related information.

### BACKGROUND

A surveillance radar system for air traffic control and flight safety may detect and track a mobility apparatus and other flight vehicles in an airport and an area around it. For example, the surveillance radar system may be mainly designed for a mobility apparatus operating at a high altitude and generally include a primary radar and a secondary radar. The primary radar radiates electromagnetic waves to receive a signal reflected from an object and measures a location and a distance of the object, and the secondary radar communicates with a transponder of the mobility apparatus to obtain additional information.

In some cases, the surveillance radar system has several limitations to detect a flight vehicle operating at a low altitude, particularly, a low-altitude flight vehicle, such as advanced air mobility (AAM), which newly emerges.

For example, a radar signal may be scattered by a geographical feature, such as the ground or a building, and may arrive at a receiver via multiple paths to cause interference and generate a large error in estimating an angle. This can be a more serious problem particularly around a complex urban environment or a vertiport.

In some cases, it may be difficult to identify an accurate location of a low-altitude flight vehicle because a detection precision of the existing surveillance radar system is low. For example, a general airport surveillance radar has an azimuth resolution error of 2 degrees and a distance detection error of less than 3%, which may be unsuitable for providing precise location information at a low altitude. Furthermore, because height information of a flight vehicle may not be directly obtained by the first radar, there is a limitation in identifying an accurate location in a three-dimensional space.

In some cases, where several surveillance radars are used, a single flight vehicle may be incorrectly recognized as several objects due to an error in each radar. This may cause confusion for a controller or a pilot and may cause a serious safety problem in a complicated low-altitude flight environment. In addition, because various access paths may be generated in a new type of take-off and landing facility such as a vertiport, there may be t a detection blind spot where a following flight vehicle is hidden by a preceding flight vehicle.

It may be difficult for the existing surveillance radar system to ensure safe operation of a high-altitude flight vehicle as well as a low-altitude flight vehicle.

### SUMMARY

The present disclosure describes a sensor fusion-based low-altitude aerial surveillance system for effectively fusing pieces of data of a plurality of sensor modules and a radar system around a take-off and landing site to accurately identify and track a low-altitude moving object and a method thereof.

The present disclosure further describes a sensor fusion-based low-altitude aerial surveillance system for resolving data inconsistency between a plurality of sensor modules and a radar system and generating accurate fusion detection data via reliability-based dynamic weight adjustment and a method thereof.

According to an aspect of the present disclosure, an aerial surveillance system includes a plurality of sensors and a radar system that are configured to detect a moving object around a take-off and landing site of a mobility apparatus, and a server configured to communicate with the plurality of sensors and the radar system, where the server includes a processor, a memory, and a network interface. The processor is configured to generate first detection data of the detected moving object based on pieces of data received from the plurality of sensors, generate second detection data of the detected moving object based on data received from the radar system, determine whether the detected moving object is a low-altitude moving object based on the first detection data, generate fusion detection data of the detected moving object based on (i) the first detection data, (ii) the second detection data, and (iii) a determination whether the detected moving object is the low-altitude moving object, and transmit the fusion detection data to one or more external systems.

Implementations according to this aspect can include one or more of the following features. For example, the one or more external systems can include at least one of an air traffic control facility, a remote mobility apparatus, a control center, or another mobility apparatus.

In some implementations, each of the first detection data, the second detection data, and the fusion detection data can include size information, location information, velocity information, direction information, height information, flight pattern information, and type information of the detected moving object, where the type information indicates whether the detected moving object is at least one of a fixed-wing mobility apparatus, a rotary-wing mobility apparatus, a drone, or a bird.

In some examples, the processor is configured to determine that the detected moving object is the low-altitude moving object based on an altitude of the detected moving object being less than or equal to a predetermined reference altitude, compare the location information of the first detection data with the location information of the second detection data, determine the first detection data as the fusion detection data of the detected moving object based on a distance between the location information of the first detection data and the location information of the second detection data being less than a predetermined radius, and add, in the fusion detection data, a data fusion indicator indicating that the first detection data is determined as the fusion detection data of the detected moving object.

In some examples, the processor is configured to assign a tracking priority of the detected moving object to be greater than a tracking priority of a high-altitude moving object based on a determination that the detected moving object is the low-altitude moving object.

In some implementations, the processor is configured to evaluate (i) a first reliability of the pieces of data of the plurality of sensors and (ii) a second reliability of the data of the radar system, and dynamically adjust weights for the first detection data and the second detection data based on a result of evaluating the first reliability and the second reliability. In some examples, the processor is configured to compare the location information of the first detection data with the location information of the second detection data, and generate the fusion detection data of the detected moving object by fusing the first detection data with the second detection data based on a distance between the location information of the first detection data and the location information of the second detection data being greater than a predetermined radius.

In some implementations, the processor is configured to track the detected moving object in real time and predict an expected route of the detected moving object based on a result of tracking the detected moving object in real time. In some examples, the processor is configured to evaluate a risk of collision of the detected moving object with another object based on the expected route of the detected moving object, and generate a warning signal based on the risk of collision being greater than a threshold.

In some implementations, each of the plurality of sensors can include at least one of a camera sensor or a light detection and ranging (LiDAR) sensor.

According to another aspect, a method for low-altitude aerial surveillance is performed by a processor of a server configured to communicate with a plurality of sensors and a radar system that are configured to detect an object around a take-off and landing site of a mobility apparatus. The method includes receiving (i) pieces of data of the plurality of sensors and (ii) pieces of data of the radar system, generating first detection data of a detected moving object based on the pieces of data of the plurality of sensors, generating second detection data of the detected moving object based on the data of the radar system, determining whether the detected moving object is a low-altitude moving object based on the first detection data, generating fusion detection data of the detected moving object based on (i) the first detection data, (ii) the second detection data, and (iii) a determination whether the detected moving object is the low-altitude moving object, and transmitting the fusion detection data of the detected moving object to one or more external systems.

Implementations according to this aspect can include one or more of the following features. For example, the one or more external systems can include at least one of an air traffic control facility, a remote mobility apparatus, a control center, or another mobility apparatus. In some implementations, each of the first detection data, the second detection data, and the fusion detection data can include size information, location information, velocity information, direction information, height information, flight pattern information, and type information of the detected moving object, where the type information indicates whether the detected moving object is at least one of a fixed-wing mobility apparatus, a rotary-wing mobility apparatus, a drone, or a bird.

In some implementations, the method includes determining that the detected moving object is the low-altitude moving object based on an altitude of the detected moving object being less than or equal to a predetermined reference altitude, comparing the location information of the first detection data with the location information of the second detection data, determining the first detection data as the fusion detection data of the detected moving object based on a distance between the location information of the first detection data and the location information of the second detection data being less than a predetermined radius, and adding, in the fusion detection data, a data fusion indicator indicating that the first detection data is determined as the fusion detection data of the detected moving object.

In some implementations, the method includes assigning a tracking priority of the detected moving object to be greater than a tracking priority of a high-altitude moving object based on a determination that the detected moving object is the low-altitude moving object. In some implementations, the method includes evaluating (i) a first reliability of the pieces of data of the plurality of sensors and (ii) a second reliability of the data of the radar system, and dynamically adjusting weights for the first detection data and the second detection data based on a result of evaluating the first reliability and the second reliability.

In some implementations, generating the fusion detection data can include comparing the location information of the first detection data with the location information of the second detection data, and generating the fusion detection data of the detected moving object by fusing the first detection data with the second detection data based on a distance between the location information of the first detection data and the location information of the second detection data being greater than a predetermined radius.

In some implementations, the method includes tracking the detected moving object in real time, and predicting an expected route of the detected moving object based on a result of tracking the detected moving object in real time. In some examples, the method includes evaluating a risk of collision of the detected moving object with another object based on the expected route of the detected moving object, and generating a warning signal based on the risk of collision being greater than a threshold.

In some implementations, each of the plurality of sensors can include at least one of a camera sensor or a light detection and ranging (LiDAR) sensor.

### BRIEF DESCRIPTION OF THE DRAWINGS

The above and other objects, features and advantages of the present disclosure will be more apparent from the following detailed description taken in conjunction with the accompanying drawings.

FIG. 1 is schematically illustrating an example of a sensor fusion-based low-altitude aerial surveillance system.

FIG. 2 is a block diagram illustrating an example configuration of the sensor fusion-based low-altitude aerial surveillance system.

FIG. 3 is a block diagram illustrating an example configuration of a sensor module.

FIG. 4 is a block diagram illustrating an example configuration of a server.

FIG. 5 illustrates an example of data flow and data processing between respective components in the sensor fusion-based low-altitude aerial surveillance system.

FIG. 6 illustrates an example of multiple radar systems and a sensor module, where first detection data form the sensor module is determined as fusion detection data if a moving object is a low-altitude moving object.

FIG. 7 illustrates more visually emphasizing and representing first detection data than second detection data in an example of a single radar system if a moving object is a low-altitude moving object.

FIG. 8 is a flowchart for describing an example of a sensor fusion-based low-altitude aerial surveillance method.

FIG. 9 is a flowchart for describing an example of sub-operations of an operation for fusing first detection data with second detection data to generate fusion detection data, if a moving object is not a low-altitude moving object or a distance between location information of the first detection data and location information of second detection data is greater than a predetermined radius.

FIG. 10 is a flowchart for describing an example of sub-operations for generating a warning signal to prevent an accident of a moving object.

### DETAILED DESCRIPTION

Hereinafter, some implementations of the present disclosure will be described in detail with reference to the example drawings.

In the present disclosure, the term, “sensor fusion-based low-altitude aerial surveillance system” can be referred to as a “low-altitude aerial surveillance system” or a “system.” The term, “sensor fusion-based low-altitude aerial surveillance method”, in the present disclosure can be referred to as a “low-altitude aerial surveillance method” or a “method.”

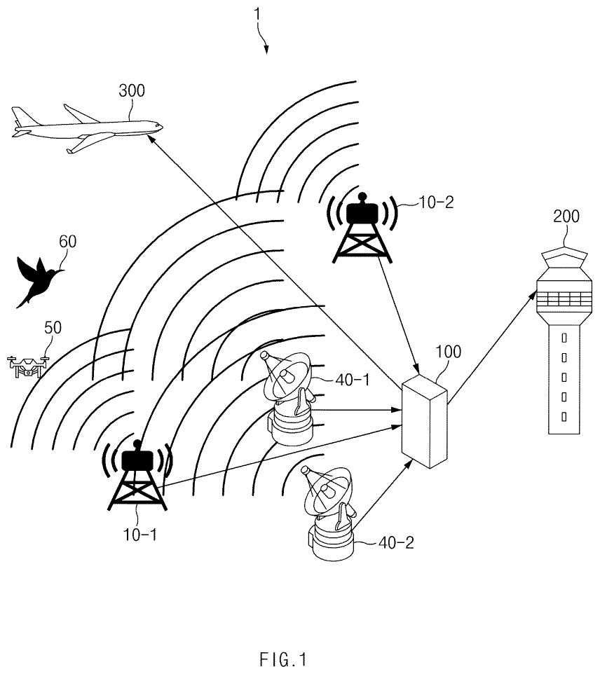

Hereinafter, implementations of the present disclosure will be described in detail with reference to FIGS. 1 to 10.

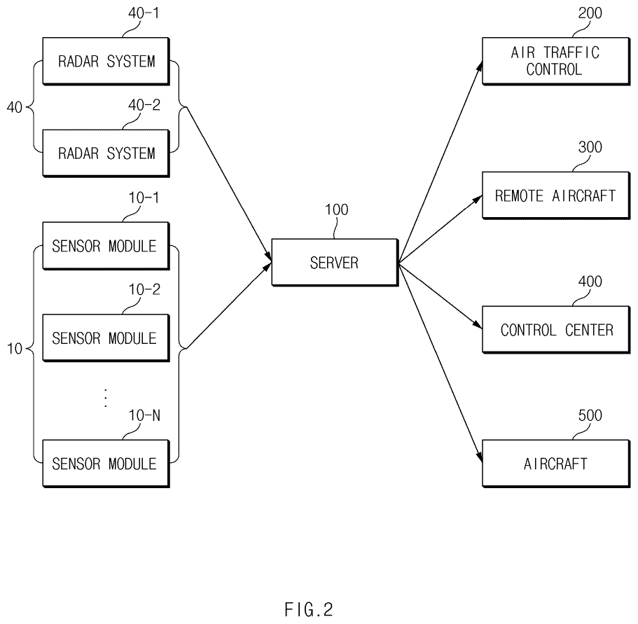

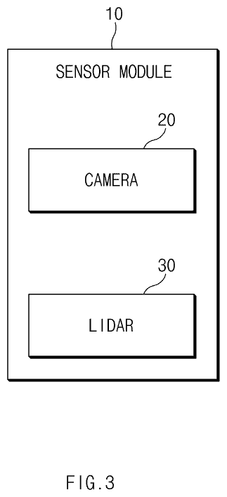

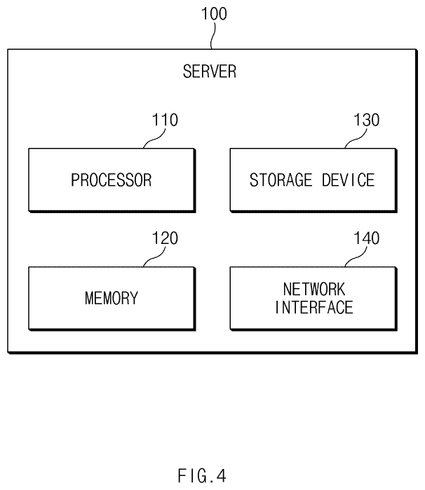

FIG. 1 is schematically illustrating an example of a sensor fusion-based low-altitude aerial surveillance system. FIG. 2 is a block diagram illustrating an example configuration of the sensor fusion-based low-altitude aerial surveillance system. FIG. 3 is a block diagram illustrating an example configuration of a sensor module. FIG. 4 is a block diagram illustrating a configuration of a server.

Referring to FIGS. 1 to 4, a sensor fusion-based low-altitude aerial surveillance system 1 can include a sensor module 10, a radar system 40, and a server 100.

Referring to FIGS. 1 and 2, the sensor module 10 can be disposed around a take-off and landing site and can be provided with a plurality of sensor modules (or sensors) 10-1, 10-2, . . . , and 10-N. The sensor module 10 can be disposed around the take-off and landing site to sense a moving object and can transmit the sensed data to the server 100. For example, the sensors 10 can be disposed within a predetermined distance from an airport.

Referring to FIG. 3, the sensor module 10 can include at least one of a camera 20 or light detection and ranging (LiDAR) 30.

The camera 20 can have a certain detection view around the take-off and landing site to obtain image data for the moving object.

For example, the camera 20 can include a high-definition digital image sensor (e.g., a complementary metal-oxide semiconductor (CMOS) or a charge-coupled device (CCD)), an optical lens system, and an image signal processor (ISP). Furthermore, the camera 20 can include various types of cameras, such as a thermal imaging camera, a near infrared (NIR) camera, and a pan-tilt-zoom (PTZ) camera. Such a camera can have an image stabilization technology, a high-sensitivity low-light image capture function, a wide-angle lens, an auto-focus adjustment mechanism, or the like and can operate together with a software algorithm, such as image compression, object recognition, and motion detection, to provide high-quality image data.

The LiDAR 30 can have a certain detection view around the take-off and landing site to obtain LiDAR data for the moving object.

For example, the LiDAR 30 can include a laser transmitter, a photodetector, a scanning mechanism, a timing circuit, a signal processor, or the like. Furthermore, the LiDAR 30 can include various types of LiDAR systems, such as rotary LiDAR, stationary solid state LiDAR, and flash LiDAR. Such a LiDAR system can use various laser technologies, such as a pulse laser, a continuous wave laser, and an optical fiber laser, and can apply a distance measurement technology, such as a time of flight or a phase difference measurement method. Furthermore, the LiDAR system can operate together with software for implementing a data processing algorithm, such as point cloud generation, object segmentation, and three-dimensional (3D) mapping, to provide precise 3D space information.

The radar system 40 can be disposed around the take-off and landing site and can be provided with a plurality of radar systems. For example, the plurality of radar systems 40 can include a first radar system 40-1 and a second radar system 40-2.

The radar system 40 can have a certain detection view around the take-off and landing site to obtain and transmit radar data for the moving object to the server 100.

For example, the radar system 40 can include a radar for aerial surveillance, such as a primary surveillance radar (PSR), a secondary surveillance radar (SSR), or a multi-function phased array radar (MPAR). Furthermore, the radar system 40 can also include a special purpose radar system, such as airport surface detection equipment (ASDE), a precision approach radar (PAR), or a weather radar. Such radar systems can be composed of hardware components, such as an antenna array, a transceiver, a signal processor, or a data integration and display system, and can operate together with a signal processing algorithm, such as Doppler processing, pulse compression, or clutter removal. A combination of such hardware and software can provide a capability for the radar system 40 to monitor a wide airspace and accurately detect a location, an altitude, a velocity, or the like of a mobility apparatus.

The server 100 can generate first detection data of the moving object based on pieces of data received from the plurality of sensor modules 10-1 and 10-2. For example, the server 100 can receive sensor data including at least one of image data or LiDAR data from the plurality of sensor modules 10-1 and 10-2 and can generate the first detection data of the moving object based on the sensor data. The server 100 can determine whether the moving object is a low-altitude moving object based on the first detection data.

The server 100 can detect a moving object around a take-off and landing site of a mobility apparatus in real time based on data from the sensors 10 and radar system 40.

The server 100 can generate second detection data of the moving object based on the data received from the radar system 40. For example, the server 100 can receive radar data from the radar system 40 and can generate the second detection data of the moving object based on the radar data.

The server 100 can generate and transmit fusion detection data of the moving object to one or more external systems 200 to 500 based on whether the moving object is the low-altitude moving object, the first detection data, and the second detection data.

For example, the server 100 can include a processor, such as an electric circuit, a central processing unit (CPU), a graphics processing unit (GPU), or a field-programmable gate array (FPGA). Furthermore, the server 100 can be implemented as a cloud server or a virtual server using a virtualization technology together with physical server hardware, for example, a rack mount server, a blade server, or a tower server. The server 100 can include an operating system for server, such as Linux, Windows Server, or Unix, web server software, such as Apache or Nginx, and a containerization platform, such as Docker, in terms of software.

The moving object can be a drone 50, a bird 60, a fixed-wing mobility apparatus, or a rotary-wing mobility apparatus. In other words, type information of the moving object can include, but is not limited to, at least one of the fixed-wing mobility apparatus, the rotary-wing mobility apparatus, the drone 50, or the bird 60 and can include a ground moving object, for example, a vehicle.

In some implementations, the one or more external systems 200 to 500 can include at least one of the air traffic control facility 200, the remote mobility apparatus 300, the control center 400, or the mobility apparatus 500. The one or more external systems 200 to 500 can receive the fusion detection data of the moving object from the server 100 and can visualize and display the fusion detection data on a display device included in each system.

Each of the first detection data, the second detection data, and the fusion detection data can include size information, location information, velocity information, direction information, height information, flight pattern information, and type information of the moving object. In some implementations, the location information can be 3D location information.

The fusion detection data can further include a fusion data indicator, (e.g., “(Modified)”), which is information indicating that the moving object is the low-altitude moving object. For example, the server 100 can determine the moving object as the low-altitude moving object based on the first detection data and then compare location information of the first detection data with location information of the second detection data with respect to the moving object to determine the first detection data as the fusion detection data of the moving object. If a distance between the location information of the first detection data the location information of the second detection data is smaller than a predetermined radius, the server 100 can include in the fusion detection data a data fusion indicator (Modified) indicating that the first detection data is determined as the fusion detection data of the moving object.

In some implementations, the fusion detection data can further include a height Boolean value (Boolean (Height)). For example, if the height Boolean value is 1 (Boolean (Height)=1), it can indicate a low altitude. If the height Boolean value is 0 (Boolean (Height)=0), it can indicate a high altitude.

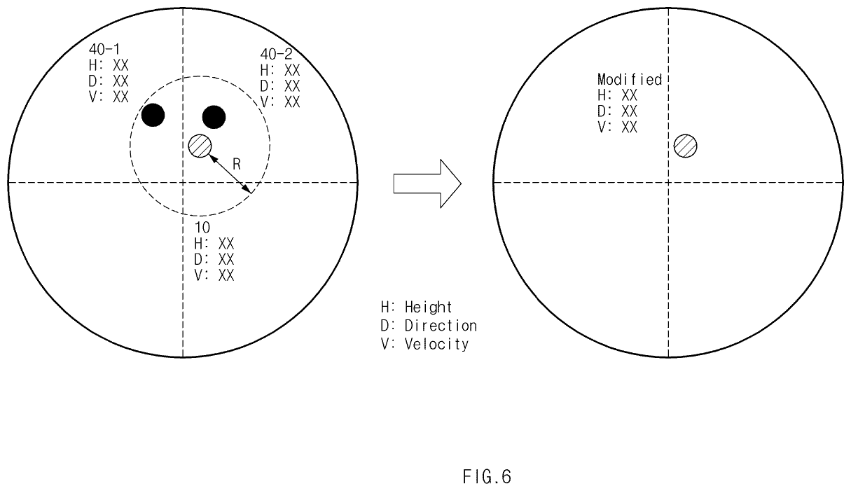

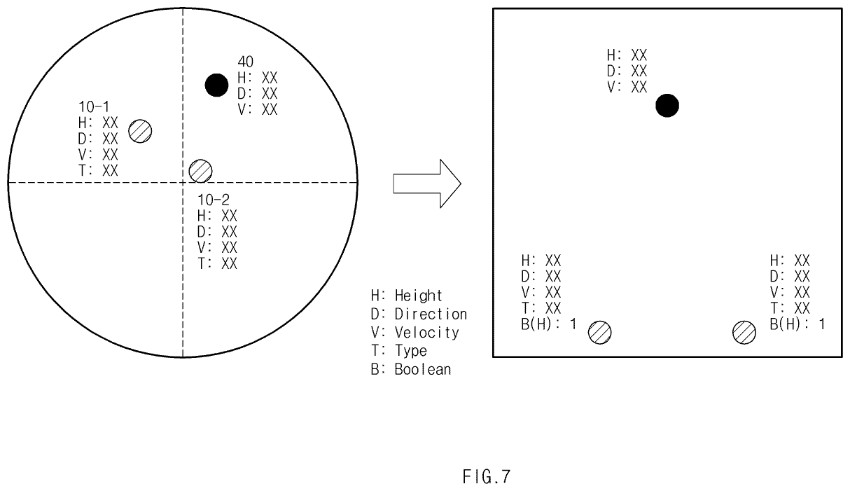

A description will be given in detail below of the data fusion indicator (Modified) and the height Boolean value (Boolean (Height)), which can be additionally included in the fusion detection data, with reference to FIGS. 6 and 7 which will be described below.

Referring to FIG. 4, the server 100 can include a processor 110, a memory 120, a storage device 130, and a network interface 140.

The processor 110 can receive pieces of data from the plurality of sensor modules 10-1 and 10-2 and the radar system 40 and can process the received pieces of data. For example, the processor 110 can generate the first detection data of the moving object based on pieces of sensor data received from the plurality of sensor modules 10-1 and 10-2. Furthermore, the processor 110 can generate the second detection data of the moving object based on radar data received from the radar system 40.

The camera 20 can have, for example, an azimuth error of 1 to 2 degrees and a distance measurement error within 1 m. The camera 20 can support up to 4K resolution and a frame rate of 60 fps and can provide horizontal 90-degree and vertical 60-degree viewing angles. The camera 20 can have low-light performance of 0.1 lux@f/1.4 and can have a dynamic range of 120 dB.

In general, the LiDAR 30 can have an azimuth error of 0.10.2 degrees and a distance measurement error of 0.010.2 m. The LiDAR 30 can have a scan capability up to 2,000,000 points per second and can provide a scan range of horizontal 360 degrees and vertical 40 degrees. The maximum measurement distance can be 200 m on the basis of a reflective index of 10%.

The radar system (on the basis of an aerial surveillance radar) 40 can have an azimuth error within 2 degrees and a distance measurement error of a larger value between less than a detection distance of 3% or 463 m. A detectable distance can be from 0.5 NM to 60/70 NM (about 0.9 km to 111/130 km) and an altitude detection range can be from the ground to 25,000 ft (about 7.6 km). The radar system 40 can have an azimuth detection range of 360 degrees and an altitude angle detection range of 0.5 degrees to 30 degrees. A minimum detectable effective sectional area can be 15 m², maximum radiation power can be 25 kW (peak power), and average radiation power can be 2.1 kW.

If detecting a moving object located above the sea level or the ground to be low, that is, at a low altitude, an existing radar system can have degraded detection performance due to an angle estimation error due to the interference effect of radar scattered waves. for above-mentioned reasons, the plurality of sensor modules 10-1 and 10-2 with relatively more excellent detection performance of the low-altitude moving object can be additionally arranged around the take-off and landing site and the first detection data generated based on pieces of sensor data of the plurality of sensor modules 10-1 and 10-2 can be used together to more precisely detect the low-altitude moving object which is difficult to be detected by only the existing radar system.

In some implementations, the processor 110 can generate the fusion detection data of the moving object based on whether the moving object is the low-altitude moving object, the first detection data, and the second detection data.

In other words, the processor 110 can be configured to fuse the first detection data with the second fusion detection data in a different manner depending on whether the moving object is the low-altitude moving object to generate the fusion detection data of the moving object.

The processor 110 can determine whether the moving object is the low-altitude moving object based on the first detection data. In detail, the processor 110 can compare the altitude of the moving object with a predetermined reference altitude based on the first detection data to determine the moving object as the low-altitude moving object, if the altitude of the moving object is less than or equal to the predetermined reference altitude.

The processor 110 can compare the location of the first detection data with the location of the second detection data with respect to the moving object, if the moving object is the low-altitude moving object, to determine whether a distance therebetween is smaller than a predetermined radius R.

If the distance therebetween is smaller than the predetermined radius R, the processor 110 can exclude the second detection data and can determine the first detection data as the fusion detection data of the moving object. This is because the reliability of the first detection data or the reliability of each of pieces of data of the plurality of sensor modules 10-1 and 10-2 is relatively greater than the reliability of the second detection data or the reliability of data of the radar system 40 if an error between the first detection data and the second detection data is not large, for the low-altitude moving object.

Thus, the processor 110 can determine the first detection data as the fusion detection data of the moving object and can further include a data fusion indicator (Modified) indicating that the first detection data is determined as the fusion detection data of the moving object in the fusion detection data.

In some implementations, if the moving object is the low-altitude moving object, the processor 110 can assign a tracking priority of the moving object to be greater than a tracking priority of the high-altitude moving object.

In some examples, if the moving object is not the low-altitude moving object, that is, if the moving object is the high-altitude moving object, the processor 110 can fuse the first detection data with the second detection data to generate the fusion detection data of the moving object.

In some implementations, the processor 110 can evaluate the reliability of each of the pieces of data of the plurality of sensor modules 10-1 and 10-2 and the reliability of the data of the radar system 40. Next, the processor 110 can dynamically adjust weights of the first detection data and the second detection data based on the reliability of each of the pieces of data of the plurality of sensor modules 10-1 and 10-2 and the reliability of the data of the radar system 40. In some implementations, the processor 110 can fuse the first detection data and the second detection data to which the adjusted weights are applied to generate the fusion detection data of the moving object.

In some implementations, the processor 110 can dynamically adjust the weights of the first detection data and the second detection data based on detection performance including a detection range and detection resolution of each of the plurality of sensor modules 10-1 and 10-2, detection performance including a detection range and detection resolution of the radar system 40, and the location of the moving object. Thus, for example, if the moving object is not the low-altitude moving object, the processor 110 can set a weight of any one with relatively better detection performance among the plurality of sensor modules 10-1 and 10-2 and the radar system 40 for the location of the moving object to be greater than weights of the others.

Returning again to the case in which the moving object is the low-altitude moving object, if the distance between the location of the first detection data and the location of the second detection data with respect to the moving object is not smaller than the predetermined radius R, the processor 110 can fuse the first detection data with the second detection data to generate the fusion detection data of the moving object.

In some examples, the processor 110 can fuse the first detection data and the second detection data to which the adjusted weights are applied to generate the fusion detection data of the moving object. In some examples, where the moving object is the low-altitude moving object, the processor 110 can set the weight of the first detection data to be greater than the weight of the second detection data. For example, as the distance between the location of the first detection data and the location of the second detection data with respect to the moving object is greater than the predetermined radius R and the difference therebetween is smaller, the processor 110 can more increase the weight of the first detection data in proportional to it and can more decrease the weight of the second detection data in inversely proportional to it. For example, as the distance between the location of the first detection data and the location of the second detection data with respect to the moving object is greater than the predetermined radius R and the difference therebetween is larger, the processor 110 can more decrease the weight of the first detection data in inversely proportional to it and can more increase the weight of the second detection data in proportional to it.

As a result, the processor 110 can implement precise detection performance for the moving object by using a sensor fusion technique for dynamically adjusting a weight regardless of whether the moving object is the low-altitude moving object and fusing the first detection data with the second detection data.

The processor 110 can transmit the generated fusion detection data of the moving object to the one or more external systems 200 to 500 via the network interface 140.

In some examples, the processor 110 can visualize and display the fusion detection data of the moving object on a display device included in the server 100.

In some implementations, the processor 110 can track the moving object in real time and can predict an expected route of the moving object based on the tracked result. The processor 110 can evaluate risk of collision with another object (e.g., a stationary object or a moving object) based on the expected route of the moving object and can generate a warning signal, if the risk of collision is greater than a threshold.

In some implementations, if there are a plurality of moving objects which are being tracked and if a distance between the plurality of moving objects is within a threshold distance, the processor 110 can generate a warning signal. In some implementations, the processor 110 can calculate a relative location and a relative velocity between the plurality of moving objects and can determine whether the distance between the plurality of moving objects is within the threshold distance based on the calculated result.

The processor 110 can notify a user of the generated warning signal via the display device and/or an audio device of the server 100. Furthermore, the processor 110 can transmit the warning signal to the one or more external systems 200 to 500.

The processor 110 can analyze the pieces of data of the plurality of sensor modules 10-1 and 10-2 and the data of the radar system 40 using a machine learning algorithm, can improve the accuracy of identification and classification of the moving object, and can train a new type of moving object. For example, the processor 110 can periodically self-diagnose performance of the system and can correct the plurality of sensor modules 10-1 and 10-2 or can automatically adjust a system parameter, depending on the diagnosed result.

In some implementations, the processor 110 can obtain identification information of the moving object and can compare a flight plan of the moving object with an actual flight path based on the identification information to determine whether there is an abnormal flight.

In some implementations, the processor 110 can transmit a control signal to the plurality of sensor modules 10-1 and 10-2 to dynamically adjust an altitude detection range depending on a maximum detection distance of each of the sensor modules 10-1 and 10-2.

The memory 120 and the storage device 130 can store a program and data for the processor 110 to implement an operation of controlling the components of the server 100.

The memory 120 can provide the processor 110 with the stored program and data and can store temporary data generated while the processor 110 operates. For example, the memory 120 can include a volatile memory, such as a static random access memory (S-RAM) or a dynamic RAM (D-RAM), and a non-volatile memory, such as a read only memory (ROM), an erasable programmable ROM (EPROM), or a flash memory.

The storage device 130 can store an operation log of each of components for long-term storage, a fusion detection data history of the tracked moving object, training data for machine learning or deep learning, or the like.

For example, the storage device 130 can include a non-volatile storage medium, such as a hard disk drive (HDD), a solid state drive (SSD), or an optical disk drive (ODD). Furthermore, the storage device 130 can include network attached storage (NAS), a magnetic tape drive, NAND flash memory-based mass storage.

The network interface 140 can receive pieces of data from the plurality of sensor modules 10-1 and 10-2 and the radar system 40 and can transmit the control signal of the processor 110 to the plurality of sensor modules 10-1 and 10-2. Furthermore, the network interface 140 can transmit the fusion detection data of the moving object and the warning signal, which are generated by the processor 110, to the one or more external systems 200 to 500.

For example, the network interface 140 can include a physical communication device, such as an Ethernet network interface card (NIC), an optical network interface, a wireless LAN card, or a cellular modem. Furthermore, the network interface 140 can include hardware devices for supporting various wired and wireless communication protocols, such as a Bluetooth module, a ZigBee module, a near field communication (NFC) module, a serial port, and a parallel port.

The one or more external systems 200 to 500 can receive the fusion detection data of the moving object from the server 100 and can visualize and display the fusion detection data on their display devices. For example, the one or more external systems 200 to 500 can three-dimensionally visualize and display a flight route of the moving object on the display devices based on 3D location information which is location information of the fusion detection data of the moving object. Furthermore, the one or more external systems 200 to 500 can separately display the moving object detected by the plurality of sensor modules 10-1 and 10-2 and the moving object detected by the radar system 40 on the display devices.

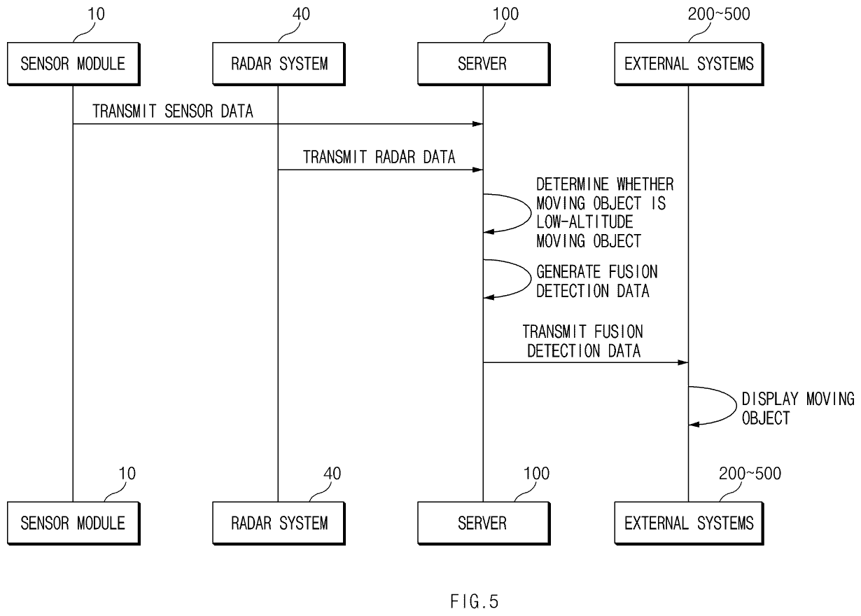

FIG. 5 illustrates data flow and data processing between respective components in a sensor fusion-based low-altitude aerial surveillance system.

Referring to FIG. 5, a sensor module 10 can transmit sensor data to a server 100.

The sensor data can include image data obtained by a camera 20 of the sensor module 10 and LiDAR data obtained by LiDAR 30 of the sensor module 10.

A radar system 40 can transmit radar data to the server 100.

The server 100 can receive the sensor data from the sensor module 10 and can receive the radar data from the radar system 40.

The server 100 can determine whether a moving object is a low-altitude moving object.

The server 100 can generate first detection data of the moving object based on pieces of sensor data received from a plurality of sensor modules 10-1 and 10-2. Furthermore, the server 100 can generate second detection data of the moving object based on the radar data received from the radar system 40.

If detecting a moving object located above the sea level or the ground to be low, that is, at a low altitude, an existing radar system can have degraded detection performance due to an angle estimation error due to the interference effect of radar scattered waves. For above-mentioned reasons, the plurality of sensor modules 10-1 and 10-2 with relatively more excellent detection performance of the low-altitude moving object can be additionally arranged around a take-off and landing site and the first detection data generated based on pieces of sensor data of the plurality of sensor modules 10-1 and 10-2 can be used together to more precisely detect the low-altitude moving object which is difficult to be detected by only the existing radar system.

In some implementations, the server 100 can generate fusion detection data of the moving object based on whether the moving object is the low-altitude moving object, the first detection data, and the second detection data.

In other words, the server 100 can be configured to fuse the first detection data with the second fusion detection data in a different manner depending on whether the moving object is the low-altitude moving object to generate the fusion detection data of the moving object.

The server 100 can determine whether the moving object is the low-altitude moving object based on the first detection data. In detail, the server 100 can compare the altitude of the moving object with a predetermined reference altitude based on the first detection data to determine the moving object as the low-altitude moving object, if the altitude of the moving object is less than or equal to the predetermined reference altitude.

The server 100 can compare the location of the first detection data with the location of the second detection data with respect to the moving object, if the moving object is the low-altitude moving object, to determine whether a distance therebetween is smaller than a predetermined radius R.

If the distance therebetween is smaller than the predetermined radius R, the server 100 can exclude the second detection data and can determine the first detection data as the fusion detection data of the moving object. This is because the reliability of the first detection data or the reliability of each of pieces of data of the plurality of sensor modules 10-1 and 10-2 is relatively greater than the reliability of the second detection data or the reliability of data of the radar system 40 if an error between the first detection data and the second detection data is not large, for the low-altitude moving object.

Thus, the server 100 can determine the first detection data as the fusion detection data of the moving object and can further include a data fusion indicator (Modified) indicating that the first detection data is determined as the fusion detection data of the moving object in the fusion detection data.

In some examples, if the moving object is not the low-altitude moving object, that is, if the moving object is the high-altitude moving object, the server 100 can fuse the first detection data with the second detection data to generate the fusion detection data of the moving object.

In some implementations, the server 100 can evaluate the reliability of each of the pieces of data of the plurality of sensor modules 10-1 and 10-2 and the reliability of the data of the radar system 40. Next, the server 100 can dynamically adjust weights of the first detection data and the second detection data based on the reliability of each of the pieces of data of the plurality of sensor modules 10-1 and 10-2 and the reliability of the data of the radar system 40. In some implementations, the server 100 can fuse the first detection data and the second detection data to which the adjusted weights are applied to generate the fusion detection data of the moving object.

In some implementations, the server 100 can dynamically adjust the weights of the first detection data and the second detection data based on detection performance including a detection range and detection resolution of each of the plurality of sensor modules 10-1 and 10-2, detection performance including a detection range and detection resolution of the radar system 40, and the location of the moving object. Thus, for example, if the moving object is not the low-altitude moving object, the server 100 can set a weight of any one with relatively better detection performance among the plurality of sensor modules 10-1 and 10-2 and the radar system 40 for the location of the moving object to be greater than weights of the others.

Returning again to the case in which the moving object is the low-altitude moving object, if the distance between the location of the first detection data and the location of the second detection data with respect to the moving object is not smaller than the predetermined radius R, the server 100 can fuse the first detection data with the second detection data to generate the fusion detection data of the moving object.

In some examples, the server 100 can fuse the first detection data and the second detection data to which the adjusted weights are applied to generate the fusion detection data of the moving object. In some examples, where the moving object is the low-altitude moving object, the server 100 can set the weight of the first detection data to be greater than the weight of the second detection data. For example, as the distance between the location of the first detection data and the location of the second detection data with respect to the moving object is greater than the predetermined radius R and the difference therebetween is smaller, the server 100 can more increase the weight of the first detection data in proportional to it and can more decrease the weight of the second detection data in inversely proportional to it. For example, as the distance between the location of the first detection data and the location of the second detection data with respect to the moving object is greater than the predetermined radius R and the difference therebetween is larger, the server 100 can more decrease the weight of the first detection data in inversely proportional to it and can more increase the weight of the second detection data in proportional to it.

As a result, the server 100 can implement precise detection performance for the moving object by using a sensor fusion technique for dynamically adjusting a weight regardless of whether the moving object is the low-altitude moving object and fusing the first detection data with the second detection data.

The server 100 can transmit the fusion detection data of the moving object to one or more external systems 200 to 500.

The one or more external systems 200 to 500 can receive the fusion detection data of the moving object from the server 100 and can visualize and display the fusion detection data on their display devices. For example, the one or more external systems 200 to 500 can three-dimensionally visualize and display a flight route of the moving object on the display devices based on 3D location information which is location information of the fusion detection data of the moving object. Furthermore, the one or more external systems 200 to 500 can separately display the moving object detected by the plurality of sensor modules 10-1 and 10-2 and the moving object detected by the radar system 40 on the display devices.

FIG. 6 visualizes and illustrates determining first detection data as fusion detection data, if a radar system is plural in number and a moving object is a low-altitude moving object,.

Referring to FIG. 6, a radar system 40 can include a first radar system 40-1 and a second radar system 40-2.

Height information, direction information, and velocity information of a moving object, which are included in second detection data of the first radar system 40-1, can be displayed. Height information, direction information, and velocity information of the moving object, which are included in second detection data of the second radar system 40-2, can be displayed.

In addition, height information, direction information, and velocity information of the moving object, which are included in first detection data of a sensor module 10, can be displayed.

Herein, the sensor module 10 can be, but is not limited to, one in number and can be a plurality of sensor modules 10-1 and 10-2. If the sensor module 10 is plural in number, respective pieces of data of the plurality of sensor modules 10-1 and 10-2 can be first fused and first sensing data can be generated.

In some cases, absolute locations of the second detection data of the first radar system 40-1, the second detection data of the second radar system 40-2, and the first detection data of the sensor module 10 may not be explicitly displayed. However, as shown at the left of FIG. 6, a relative location for each detection data can be intuitively visualized and displayed.

Because a distance between the location of the moving object, which is detected by the first radar system 40-1, and the location of the moving object, which is detected by the second radar system 40-2, is smaller than a predetermined radius R, as shown at the right of FIG. 6, the first detection data can be determined as fusion detection data. At this time, “Modified” can refer to a data fusion indicator indicating that the first detection data is determined as the fusion detection data. The data fusion indicator (Modified) can be included in the fusion detection data. Thus, if recognizing the data fusion indicator (Modified) included in the fusion detection data, external systems 200 to 500 can identify the moving object as a low-altitude moving object. In some examples, when a distance between the locations of the moving object that are detected by the sensor module 10 and the first radar system 40-1 (or the second radar system 40-2) is smaller than the predetermined radius R, the first detection data can be determined as fusion detection data.

In some implementations, as shown in FIG. 6, the first detection data and the second detection data can be differently visualized and displayed to be distinguished from each other.

FIG. 7 illustrates more visually emphasizing and representing first detection data than second detection data, if a radar system is one in number and a moving object is a low-altitude moving object,.

In FIG. 7, a radar system 40 can be one in number and a sensor module 10 can be a plurality of sensor modules 10-1 and 10-2.

Because the radar system 40 is one in number and there is no separate additional radar system, height, direction, velocity, and type information of the moving object in first detection data of each of the plurality of sensor modules 10-1 and 10-2 can be displayed and height, direction, and velocity information of the moving object in second detection data of the radar system 40 can be displayed.

At this time, as shown at the right of FIG. 7, a height Boolean value (Boolean (Height)=1) indicating that the moving object is a low-altitude moving object can be added to the height, direction, velocity, and type information of the moving object in the first detection data of each of the plurality of sensor modules 10-1 and 10-2 to be additionally displayed. In addition, it can be verified that information of the moving object, which is displayed based on the first detection data of each of the plurality of sensor modules 10-1 and 10-2, is more visually emphasize and represented than information of the moving object, which is displayed based on the second detection data of the radar system 40.

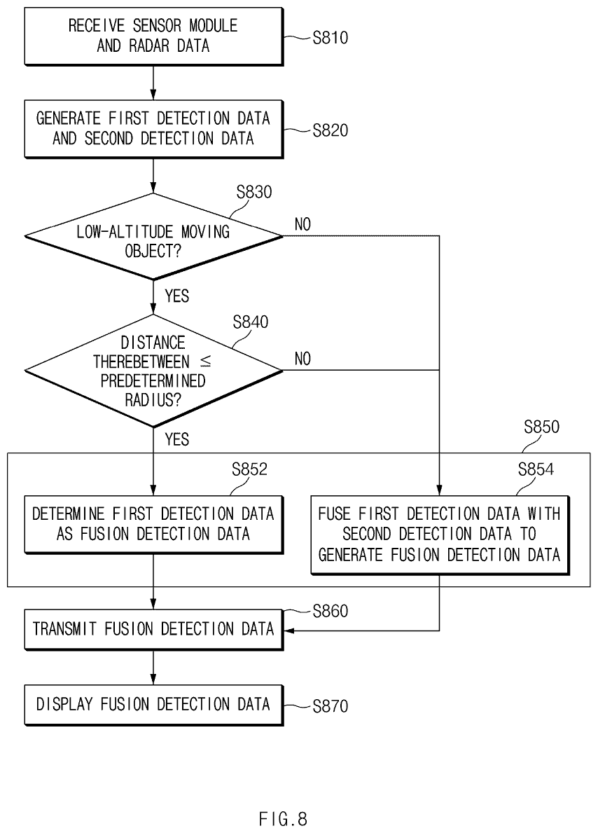

FIG. 8 is a flowchart for describing a sensor fusion-based low-altitude aerial surveillance method.

Referring to FIG. 8, the sensor fusion-based low-altitude aerial surveillance method can include receiving (S810) sensor module and radar data, generating (S820) first detection data and second detection data, determining (S830) whether a moving object is a low-altitude moving object, determining (S840) whether a distance between a location of the first detection data and a location of the second detection data with respect to the moving object is smaller than a predetermined radius R, if the moving object is the low-altitude moving object, generating (S850) fusion detection data, transmitting (S860) the fusion detection data to external systems 200 to 500, and displaying (S870) the fusion detection data.

In receiving (S810) the sensor module and radar data, a processor 110 of a server 100 can receive pieces of data from a plurality of sensor modules 10-1 and 10-2 and a radar system 40.

In generating (S820) the first detection data and the second detection data, the processor 110 of the server 100 can generate the first detection data of the moving object based on pieces of sensor data received from the plurality of sensor modules 10-1 and 10-2 and can generate the second detection data of the moving object based on radar data received from the radar system 40.

In determining (S830) whether the moving object is the low-altitude moving object, the processor 110 of the server 100 can determine whether the moving object is the low-altitude moving object based on the first detection data.

In determining (S840) whether the distance between the location of the first detection data and the location of the second detection data with respect to the moving object is smaller than the predetermined radius R, if the moving object is the low-altitude moving object, the processor 110 of the server 100 can compare an altitude of the moving object with a predetermined reference altitude based on the first detection data and can determine the moving object as the low-altitude moving object, if the altitude of the moving object is less than or equal to the predetermined reference altitude.

Generating (S850) the fusion detection data can include determining (S852) the first detection data as the fusion detection data and fusing (S854) the first detection data with the second detection data to generate the fusion detection data.

In determining (S852) the first detection data as the fusion detection data, the processor 110 of the server 100 can compare the location of the first detection data with the location of the second detection data with respect to the moving object, if the moving object is the low-altitude moving object, and can exclude the second detection data and can determine the first detection data as the fusion detection data of the moving object, if the distance therebetween is smaller than the predetermined radius R.

In fusing (S854) the first detection data with the second fusion detection data to generate the fusion detection data, the processor 110 of the server 100 can fuse the first detection data with the second fusion detection data to generate the fusion detection data of the moving object, if the moving object is not the low-altitude moving object, that is, if the moving object is a high-altitude moving object. Alternatively, if the moving object is the low-altitude moving object and the distance between the location of the first detection data and the location of the second detection data with respect to the moving object is not smaller than the predetermined radius R, the processor 110 can fuse the first detection data with the second detection data to generate the fusion detection data of the moving object.

In transmitting (S860) the fusion detection data to the external systems 200 to 500, the processor 110 of the server 100 can transmit the generated fusion detection data of the moving object to the one or more external systems 200 to 500 via a network interface 140.

In displaying (S870) the fusion detection data, the one or more external systems 200 to 500 can receive the fusion detection data of the moving object from the server 100 and can visualize and display the fusion detection data on their display devices.

Alternatively, in displaying (S870) the fusion detection data, the processor 110 of the server 100 can visualize and display the fusion detection data of the moving object on a display device included in the server 100.

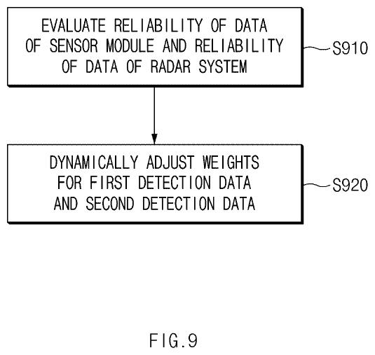

FIG. 9 is a flowchart for describing sub-operations for fusing first detection data with second detection data to generate fusion detection data, if a moving object is not a low-altitude moving object or a distance between location information of the first detection data and location information of second detection data is greater than a predetermined radius,.

Referring to FIG. 9, fusing (S854) first detection data with second detection data to generate fusion detection data can include evaluating (S910) reliability of data of a sensor module and reliability of data of a radar system and dynamically adjusting (S920) weights for the first detection data and the second detection data.

In evaluating (S910) the reliability of the data of the sensor module and the reliability of the data of the radar system, a processor 110 of a server 100 can evaluate reliability of each of pieces of data of a plurality of sensor modules 10-1 and 10-2 and reliability of data of a radar system 40.

In dynamically adjusting (S920) the weights for the first detection data and the second detection data, the processor 110 of the server 100 can dynamically adjust the weights of the first detection data and the second detection data based on the reliability of each of the pieces of data of the plurality of sensor modules 10-1 and 10-2 and the reliability of the data of the radar system 40.

In some implementations, in dynamically adjusting (S920) the weights for the first detection data and the second detection data, the processor 110 can dynamically adjust the weights of the first detection data and the second detection data based on detection performance including a detection range and detection resolution of each of the plurality of sensor modules 10-1 and 10-2, detection performance including a detection range and detection resolution of the radar system 40, and the location of the moving object. Thus, for example, if the moving object is not the low-altitude moving object, the processor 110 can set a weight of any one with relatively better detection performance among the plurality of sensor modules 10-1 and 10-2 and the radar system 40 for the location of the moving object to be greater than weights of the others. Furthermore, if the moving object is the low-altitude moving object, the processor 110 can set the weight of the first detection data to be greater than the weight of the second detection data. For example, as the distance between the location of the first detection data and the location of the second detection data with respect to the moving object is greater than the predetermined radius R and the difference therebetween is smaller, the processor 110 can more increase the weight of the first detection data in proportional to it and can more decrease the weight of the second detection data in inversely proportional to it. For example, as the distance between the location of the first detection data and the location of the second detection data with respect to the moving object is greater than the predetermined radius R and the difference therebetween is larger, the processor 110 can more decrease the weight of the first detection data in inversely proportional to it and can more increase the weight of the second detection data in proportional to it.

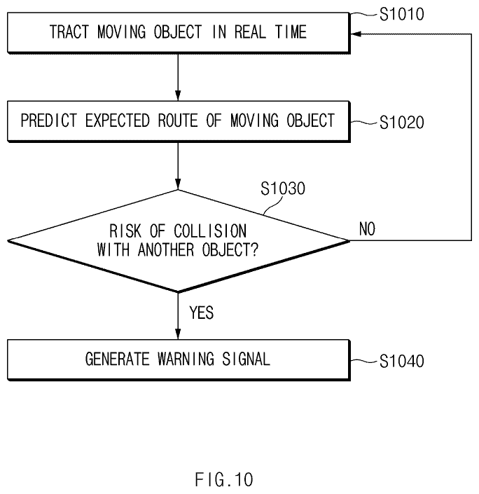

FIG. 10 is a flowchart for describing sub-operations for generating a warning signal to prevent an accident of a moving object.

Referring to FIG. 10, generating a warning signal to prevent an accident of a moving object can include tracking (S1010) the moving object in real time, predicting (S1020) an expected route of the moving object, determining (S1030) risk of collision with another object, and generating (S1040) the warning signal, if the risk of collision is determined.

In tracking (S1010) the moving object in real time, a processor 110 of a server 100 can track the moving object in real time.

In predicting (S1020) the expected route of the moving object, the processor 110 of the server 100 can predict the expected route of the moving object based on the tracked result.

In determining (S1030) the risk of collision with the other object, the processor 110 of the server 100 can evaluate the risk of collision with the other object (e.g., a stationary object or a moving object) based on the expected route of the moving object and can determine the risk of collision with the other object, if the risk of collision is greater than a threshold.

In generating (S1040) the warning signal, if the risk of collision is determined, the processor 110 of the server 100 can generate the warning signal, if the risk of collision is greater than the threshold. In some implementations, if there are a plurality of moving objects which are being tracked and if a distance between the plurality of moving objects is within a threshold distance, the processor 110 can generate a warning signal. In some implementations, the processor 110 can calculate a relative location and a relative velocity between the plurality of moving objects and can determine whether the distance between the plurality of moving objects is within the threshold distance based on the calculated result.

In some examples, after S1040, generating the warning signal to prevent the accident of the moving object can further include notifying a user of the generated warning signal via a display device and/or an audio device of the server 100. Furthermore, generating the warning signal to prevent the accident of the moving object can further include transmitting, by the processor 110 of the server 100, the warning signal to one or more external systems 200 to 500.

The present disclosure can provide the sensor fusion-based low-altitude aerial surveillance system for effectively fusing pieces of data of a plurality of sensor modules and a radar system, which are arranged around a take-off and landing site, to more accurately identify and track a low-altitude moving object and the method thereof.

Furthermore, the present disclosure can provide the sensor fusion-based low-altitude aerial surveillance system for assigning a priority based on a type and an altitude of a moving object and determining a tracking target to efficiently use limited resources to enable intensive monitoring for a certain moving object and the method thereof. That is, the aerial surveillance system can improve aerial surveillance technology by efficiently allocating limited resources to enable real time monitoring of moving objects.

In addition, the present disclosure can provide the system for resolving data inconsistency between the plurality of sensor modules and the radar system and generating accurate fusion detection data via reliability-based dynamic weight adjustment to provide more reliable low-altitude aerial surveillance information and the method thereof.

Finally, the present disclosure can provide the sensor fusion-based low-altitude aerial surveillance system for predicting an expected route of the moving object in real time and evaluating risk of collision to detect a potential safety threat in advance and provide the parties involved with a warning signal in time and the method thereof.

In addition, various effects ascertained directly or indirectly through the present disclosure can be provided.

Hereinabove, although the present disclosure has been described with reference to example implementations and the accompanying drawings, the present disclosure is not limited thereto, but can be variously modified and altered by those skilled in the art to which the present disclosure pertains without departing from the spirit and scope of the present disclosure claimed in the following claims.

Therefore, implementations of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An aerial surveillance system, comprising:
a plurality of sensors and a radar system that are configured to detect a moving object around a take-off and landing site of a mobility apparatus; and
a server configured to communicate with the plurality of sensors and the radar system, the server comprising a processor, a memory, and a network interface,
wherein the processor is configured to:
generate first detection data of the detected moving object based on pieces of data received from the plurality of sensors,
generate second detection data of the detected moving object based on data received from the radar system,
determine whether the detected moving object is a low-altitude moving object based on the first detection data,
generate fusion detection data of the detected moving object based on (i) the first detection data, (ii) the second detection data, and (iii) a determination whether the detected moving object is the low-altitude moving object, and
transmit the fusion detection data to one or more external systems.

2. The aerial surveillance system of claim 1, wherein the one or more external systems comprise at least one of an air traffic control facility, a remote mobility apparatus, a control center, or another mobility apparatus.

3. The aerial surveillance system of claim 1, wherein each of the first detection data, the second detection data, and the fusion detection data comprises size information, location information, velocity information, direction information, height information, flight pattern information, and type information of the detected moving object, and
wherein the type information indicates whether the detected moving object is at least one of a fixed-wing mobility apparatus, a rotary-wing mobility apparatus, a drone, or a bird.

4. The aerial surveillance system of claim 3, wherein the processor is configured to:
determine that the detected moving object is the low-altitude moving object based on an altitude of the detected moving object being less than or equal to a predetermined reference altitude;
compare the location information of the first detection data with the location information of the second detection data;
determine the first detection data as the fusion detection data of the detected moving object based on a distance between the location information of the first detection data and the location information of the second detection data being less than a predetermined radius; and
add, in the fusion detection data, a data fusion indicator indicating that the first detection data is determined as the fusion detection data.

5. The aerial surveillance system of claim 4, wherein the processor is configured to:
assign a tracking priority of the detected moving object to be greater than a tracking priority of a high-altitude moving object based on a determination that the detected moving object is the low-altitude moving object.

6. The aerial surveillance system of claim 3, wherein the processor is configured to:
evaluate (i) a first reliability of the pieces of data of the plurality of sensors and (ii) a second reliability of the data of the radar system; and
dynamically adjust weights for the first detection data and the second detection data based on a result of evaluating the first reliability and the second reliability.

7. The aerial surveillance system of claim 6, wherein the processor is configured to:
compare the location information of the first detection data with the location information of the second detection data; and
generate the fusion detection data of the detected moving object by fusing the first detection data with the second detection data based on a distance between the location information of the first detection data and the location information of the second detection data being greater than a predetermined radius.

8. The aerial surveillance system of claim 5, wherein the processor is configured to:
track the detected moving object in real time; and
predict an expected route of the detected moving object based on a result of tracking the detected moving object in real time.

9. The aerial surveillance system of claim 8, wherein the processor is configured to:
evaluate a risk of collision of the detected moving object with another object based on the expected route of the detected moving object; and
generate a warning signal based on the risk of collision being greater than a threshold.

10. The aerial surveillance system of claim 1, wherein each of the plurality of sensors comprises at least one of a camera sensor or a light detection and ranging (LiDAR) sensor.

11. A method for low-altitude aerial surveillance, the method being performed by a processor of a server configured to communicate with a plurality of sensors and a radar system that are configured to detect an object around a take-off and landing site of a mobility apparatus, the method comprising:
receiving (i) pieces of data of the plurality of sensors and (ii) pieces of data of the radar system;
generating first detection data of a detected moving object based on the pieces of data of the plurality of sensors;
generating second detection data of the detected moving object based on the data of the radar system;
determining whether the detected moving object is a low-altitude moving object based on the first detection data;
generating fusion detection data of the detected moving object based on (i) the first detection data, (ii) the second detection data, and (iii) a determination whether the detected moving object is the low-altitude moving object; and
transmitting the fusion detection data of the detected moving object to one or more external systems.

12. The method of claim 11, wherein the one or more external systems comprise at least one of an air traffic control facility, a remote mobility apparatus, a control center, or another mobility apparatus.

13. The method of claim 11, wherein each of the first detection data, the second detection data, and the fusion detection data comprises size information, location information, velocity information, direction information, height information, flight pattern information, and type information of the detected moving object, and
wherein the type information indicates whether the detected moving object is at least one of a fixed-wing mobility apparatus, a rotary-wing mobility apparatus, a drone, or a bird.

14. The method of claim 13, further comprising:
determining that the detected moving object is the low-altitude moving object based on an altitude of the detected moving object being less than or equal to a predetermined reference altitude;
comparing the location information of the first detection data with the location information of the second detection data;
determining the first detection data as the fusion detection data of the detected moving object based on a distance between the location information of the first detection data and the location information of the second detection data being less than a predetermined radius; and
adding, in the fusion detection data, a data fusion indicator indicating that the first detection data is determined as the fusion detection data.

15. The method of claim 14, further comprising:
assigning a tracking priority of the detected moving object to be greater than a tracking priority of a high-altitude moving object based on a determination that the detected moving object is the low-altitude moving object.

16. The method of claim 13, further comprising:
evaluating (i) a first reliability of the pieces of data of the plurality of sensors and (ii) a second reliability of the data of the radar system; and
dynamically adjusting weights for the first detection data and the second detection data based on a result of evaluating the first reliability and the second reliability.

17. The method of claim 16, wherein generating the fusion detection data comprises:
comparing the location information of the first detection data with the location information of the second detection data; and
generating the fusion detection data of the detected moving object by fusing the first detection data with the second detection data based on a distance between the location information of the first detection data and the location information of the second detection data being greater than a predetermined radius.

18. The method of claim 15, further comprising:
tracking the detected moving object in real time; and
predicting an expected route of the detected moving object based on a result of tracking the detected moving object in real time.

19. The method of claim 18, further comprising:
evaluating a risk of collision of the detected moving object with another object based on the expected route of the detected moving object; and
generating a warning signal based on the risk of collision being greater than a threshold.

20. The method of claim 11, wherein each of the plurality of sensors comprises at least one of a camera sensor or a light detection and ranging (LiDAR) sensor.
